(19) United States
(12) Patent Application Publication
(10) Pub. No.: US 2003/0074304 A1
(43) Pub. Date: Apr. 17, 2003

(54) Electric power trading market system and electric power trading method

(76) Inventor: Yasuharu Okada, Kawasaki (JP)

Correspondence Address: DICKSTEIN SHAPIRO MORIN & OSHINSKY LLP, 2101 L STREET NW, WASHINGTON, DC, 20037-1526, US

(21) Appl. No.: 10/253,663

(22) Filed: Sep. 25, 2002

(30) Foreign Application Priority Data
Oct. 12, 2001 (JP) 2001-315824

(51) Int. Cl. G06F 17/60

(52) U.S. Cl. 705/37; 705/412

(57) ABSTRACT

The present invention is intended to improve liquidity of electric power as a commodity, to substantially alleviate simultaneity of electric power supply, and to implement wheeling of the electric power among different regional blocks without restriction of the amount of interchangeable electric power, power supply frequency and the like. In order to improve the liquidity of the electric power as a commodity, an electric power trading market by means of a computer using a communication network such as the Internet so that electric power sellers (electric power generating utilities, PPS and so on) and electric power buyers (consumers, PPS and so on) can trade the electric power via the electric power trading market computer, and further, in order to substantially alleviate simultaneity of electric power supply, an electronic bill that imposes on the electric power buyers obligations to supply the electric power corresponding to the amount of the bought electric power at an arbitrary time period is issued wherein the electronic bill is transferable. Still further, in order to substantially implement supply of the electric power among the different regional blocks without restriction of the amount of interchangeable electric power, the electric power trading market is extended to a wider area consisting of regional blocks of a plurality of electric power utility companies.

### BACKGROUND OF THE INVENTION

The present invention relates to an electric power trading market system and an electric power trading method for trading electric power via a communication network such as the Internet using a computer.

Power producers and suppliers (hereinafter abbreviated as the PPS as appropriated) that satisfy certain specific conditions can sell electric power they generate or procure for themselves to third-party consumers via transmission networks of electric power utility companies. Further, the PPS can interchange the electric power by transmitting the electric power they generate or procure for themselves to consumer facilities that are related to the PPS themselves and located at a remote distance via the transmission networks of the electric power utility companies. It allows the electric power generation or other facilities to be utilized efficiently.

Hereupon, since the electric power typically cannot be stored, so-called simultaneity is always required wherein electric power generating utilities must generate and supply the electric power having as much energy as consumers are requiring. For example, in a transmission network in an identical regional block or in a transmission network in the other regional block, assume that one utility acts not only as an electric power generating utility Y6 but also as a consumer Y4. In such case, the electric power can be interchanged between the electric power generating utility Y6 and the consumer Y4 with simple procedure since they are one identical utility. But, the electric power cannot be interchanged unless supply-demand conditions such as, for example, supply-demand timing coincide between the electric power generating utility Y6 and the consumer Y4. Further, the electric power generating utility Y6 would typically wish to sell the electric power at a price as high as possible while the consumer Y4 would typically wish to buy the electric power at a price as low as possible. Necessity of supply-demand simultaneity of the electric power may prevent such operation that is advantageous to both parties. Thus, with regard to the electric power, there is an inherent problem in that it has low liquidity as a commodity.

On the other hand, in our country, the whole territory is divided into a plurality of regional blocks and the transmission networks of the electric power utility companies are built in each of the regional blocks. Therefore, when the electric power interchange is attempted between the electric power generating utility Y6 and the consumer Y4 that are one identical utility as described above, unless the electric power generating utility Y6 and the consumer Y4 belong to the same regional block, the electric power must be transmitted via transmission networks in other regional blocks. In such case, since a wheeling charge must be paid to every electric power utility company in each of the regional blocks through which the electric power is transmitted, the advantage such as in the case of the electric power wheeling within one utility may not be enjoyed due to the additional expenses of the wheeling charge. Further, the amount of wheeled electric power may be restricted by limitations of the amount of the electric power that can be interchanged among the transmission networks in the regional blocks. Still further, the wheeling of the electric power to some regional blocks may be restricted because of the difference of power supply frequency among the regional blocks.

### SUMMARY OF THE INVENTION

Therefore, it is an object of the present invention to solve the above problems, in particular, to improve liquidity of electric power as a commodity.

Further, it is another object of the present invention to substantially alleviate simultaneity of electric power supply.

Still further, it is yet another object of the present invention to wheel the electric power among different regional blocks without restriction of the amount of interchangeable electric power, power supply frequency and the like.

The present invention has been made to achieve the above object using means described below.

According to a first aspect of the present invention, in order to improve liquidity of electric power as a commodity, an electric power trading market system is created through the use of a communication network such as the Internet so that electric power sellers who wish to sell the electric power (electric power generating utilities, PPS and so on) and electric power buyers who wish to buy the electric power (consumers, PPS and so on) can trade the electric power according to their supply and demand via a computer, and as a consequence, the liquidity of the electric power as a commodity can be improved.

More specifically, it can be implemented by providing an electric power trading market system comprising a computer that is managed by an electric power trading market administrator and connected to a communication network, wherein the computer comprises: outputting means for outputting to the communication network a screen for electric power sellers on which the electric power sellers and electric power selling conditions are input; electric power sellers registering means for registering the electric power sellers and the electric power selling conditions that are input on the screen for the electric power sellers; auctioning means for publishing the electric power selling conditions registered by the electric power sellers registering means via the communication network to put up to auction for electric power buyers; electric power buyers registering means for registering the electric power buyers and electric power buying conditions that are input in response to the auction; selling and buying conditions comparing means for creating a comparison list including one or a plurality of the electric power buyers and the electric power buying conditions by comparing the electric power selling conditions and the electric power buying conditions and for transmitting the comparison list to the electric power sellers; and contracting means for concluding a trading contract based upon a reply to the comparison list from the electric power sellers and for transmitting the trading contract to the electric power sellers and the electric power buyers that are concerned via the communication network.

Further, according to a second aspect of the present invention, in place of payment of an electric power charge to the electric power sellers, an electronic bill that describes electric power payment obligations to supply the electric power corresponding to the amount of the bought electric power at an arbitrary time period is issued, wherein the electronic bill is transferable so that the supply-demand simultaneity of the electric power can be substantially alleviated and the liquidity of the electric power as a commodity can be improved. Here, though it is assumed in the above description that the payment with the electric power is made at an arbitrary time period, it may also be made at a specific time period in a limited manner, wherein the payment obligations with the amount of the electric power larger than the bought electric power may be imposed according to the supply-demand conditions at the electric power trading market.

More specifically, in the electric power trading market system described above, the computer may further comprise electronic bill issuing means for issuing an electronic bill that describes electric power payment obligations to supply electric power corresponding to the amount of the bought electric power at an arbitrary time period in place of payment of an electric power charge by the electric power buyers in the trading contract when the trading contract is concluded.

In this case, preferably, the electric power trading market administrator may transfer the electronic bill issued by the electronic bill issuing means to another party and the party to which the electronic bill is transferred may have a right to be supplied the amount of the electric power specified in the electronic bill at an arbitrary time period in an arbitrary region subject to management by the electric power trading market administrator.

Still further, according to a third aspect of the present invention, by extending the electric power trading market to a wider area consisting of a plurality of regional blocks, in virtue of the liquidity of the electronic bill, the electric power can be supplied among different regional blocks without restriction of the amount of interchangeable electric power, power supply frequency and the like.

More specifically, in the electric power trading market system described above, the area that is subject to the management by the electric power trading market administrator may be extended to a larger area including a plurality of regional blocks that are managed by a plurality of electric power utility companies.

Still further, in any of the aspects of the electric power trading market system described above, preferably, the computer may further comprise monitoring means for managing execution of the trading contract concluded by the contracting means, wherein the monitoring means may monitor the electric power selling conditions and the electric power buying conditions according to the trading contract via communicating means such as the communication network. In this case, preferably, the monitoring means may notify the electric power sellers and the electric power buyers that the issued electronic bill becomes invalid if the monitoring means determines that it is difficult to execute the trading contract concluded by the contracting means.

Still further, the electric power trading market administrator may be a power producer and supplier or a third-party organization, and the electric power sellers may include at least one of the electric power generating utilities and the power producer and suppliers while the electric power buyers may include at least one of the consumers and the power producer and suppliers.

### BRIEF DESCRIPTION OF THE DRAWINGS

Other objects and advantages of the invention will become apparent from the following description of embodiments with reference to the accompanying drawings in which:

FIG. 1 is a conceptual block diagram of an embodiment of an electric power trading market system according to the present invention;

FIG. 2 is a diagram for describing an example of an electric power trading transaction; and

FIG. 3 is a flow chart showing an embodiment of a processing procedure of a computer in the electric power trading market.

### DESCRIPTION OF THE PREFERRED EMBODIMENTS

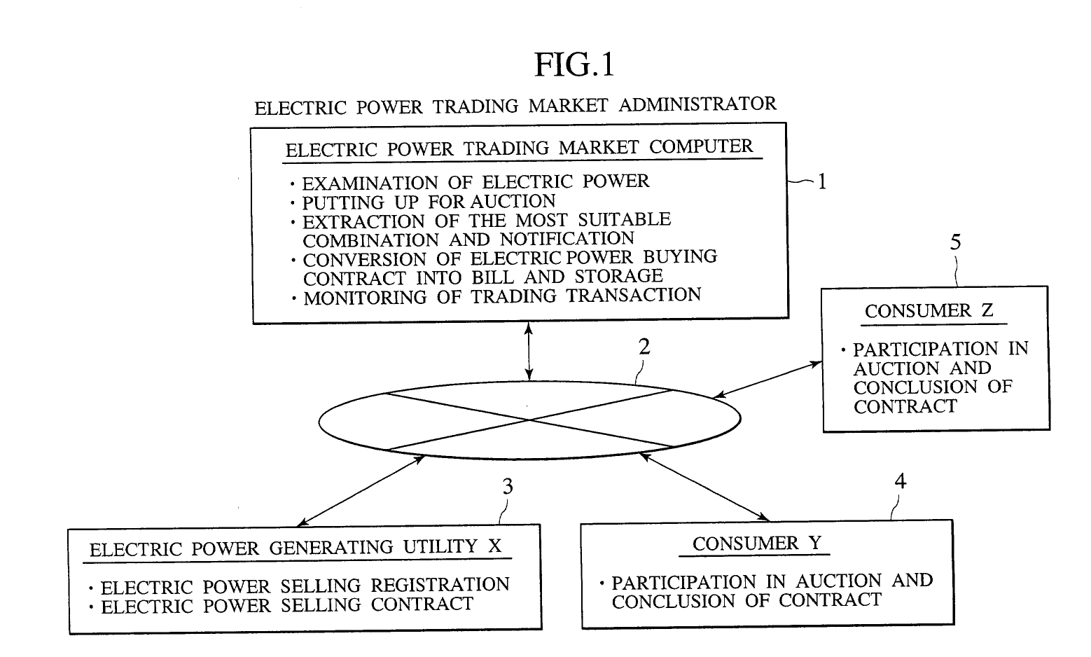

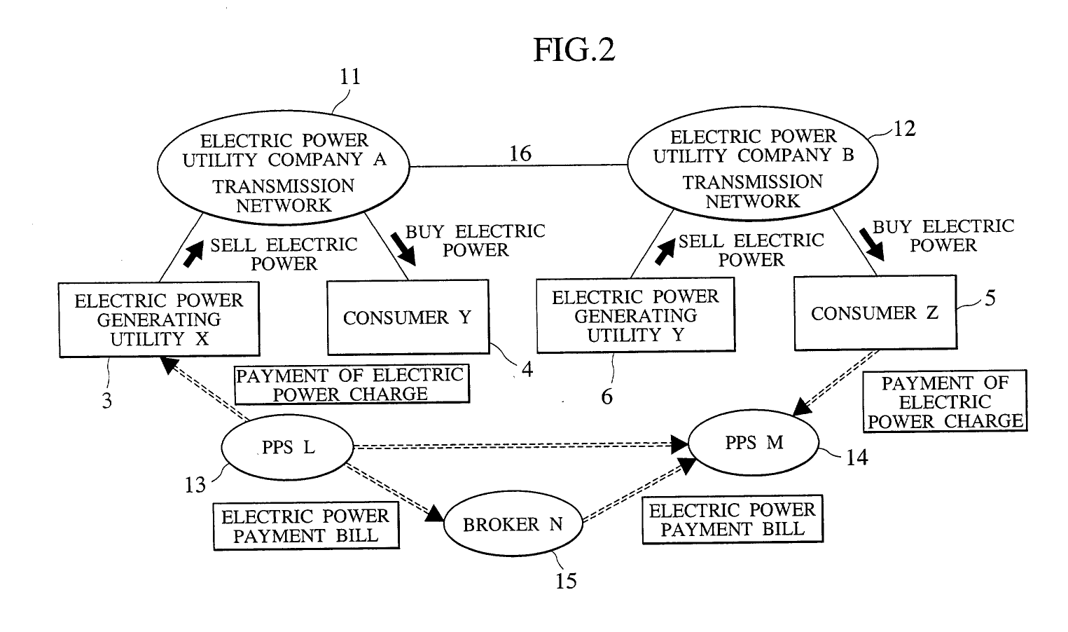

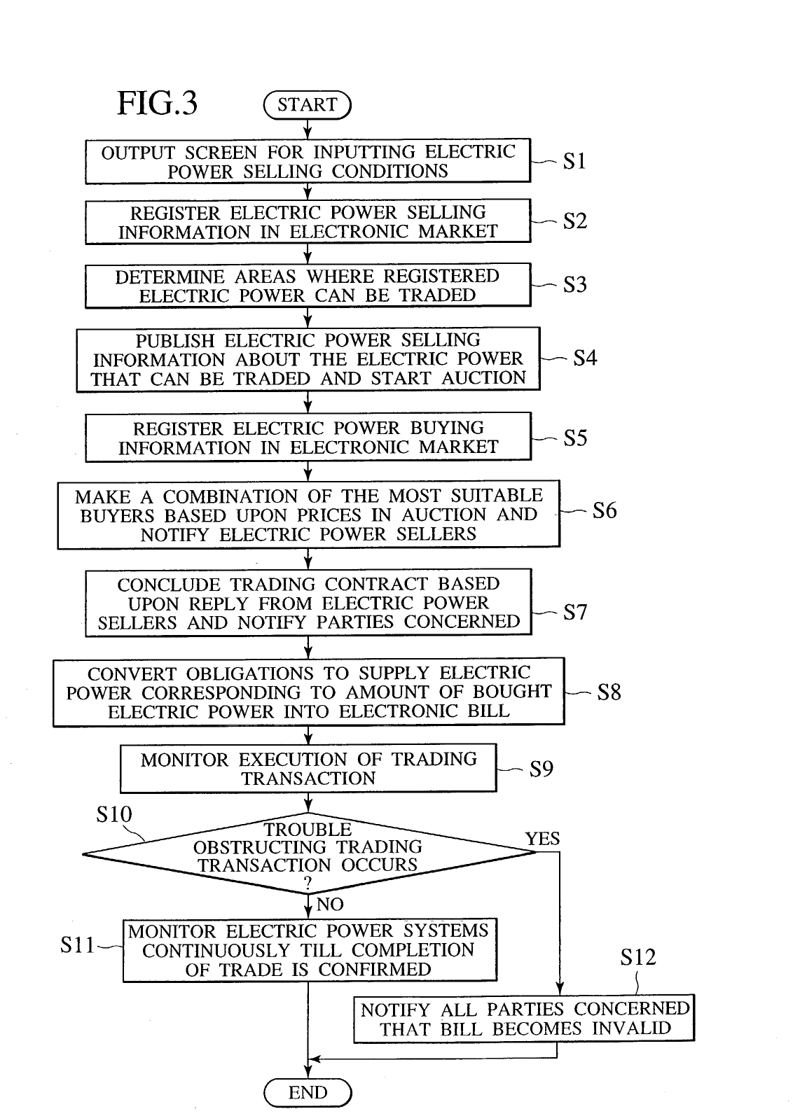

Hereinafter, an embodiment of the present invention will be described with reference to FIGS. 1-3. FIG. 1 is a conceptual block diagram of an embodiment of an electric power trading market system according to the present invention, FIG. 2 is a diagram for describing an example of an electric power trading transaction, and FIG. 3 is a flow chart showing an embodiment of a processing procedure of a computer in the electric power trading market.

As shown in FIG. 1, the electric power trading market system according to the present invention comprises an electric power trading market computer (hereinafter abbreviated simply as the “computer”) 1 that is managed by an electric power trading market administrator and connected to a communication network 2 so that the computer 1 can communicate with an electric power generating utility X3, a consumer Y4 and a consumer Z5 that are connected to the communication network 2. Preferably, the communication network 2 is a wide area communication line such as the Internet.

Here, an example of a specific trading transaction of the electric power will be described with reference to FIG. 2. In the figure, the electric power generating utility X3 and the consumer Y4 have electric power generation facilities or consumer facilities connected to a transmission network 11 of an electric power utility company A. On the other hand, the electric power generating utility Y6 and the consumer Z5 have electric power generation facilities or consumer facilities connected to a transmission network 12 of an electric power utility company B. The transmission network 11 of the electric power utility company A and the transmission network 12 of an electric power utility company B are configured so that they can interchange the electric power each other via an interchanging transmission network 16.

In this example, it is assumed that a PPS (Power Producer and Supplier) L13 and a PPS M14 each are an electric power trading market administrator and form one electric power trading market. Further, it is assumed that the PPS L13 intermediates between the electric power generating utility X3 and the consumer Y4 in their electric power trading and the PPS M14 intermediates between the electric power generating utility Y6 and the consumer Z5 in their electric power trading. When the electric power trading is concluded between the electric power generating utility X3 and the consumer Y4, the electric power generating utility X3 generates the electric power in the amount and at the time period required by the consumer Y4 and wheels the electric power to the consumer Y4 via the transmission network 11. In this case, an electric power charge fixed by the contract is paid to the electric power generating utility X3 through the intermediation of the PPS L13. Here, it is to be noted that the electric power charge includes a wheeling charge to be paid to the electric power utility company A. Then, assume that the consumer Y4 has electric power generation facilities in a regional block of the electric power utility company B and has surplus electric power that can be sold in the capacity of the electric power generating utility Y6. In this case, if the electric power generating utility Y6 can supply the surplus electric power to the consumer Y4 that belongs to an identical utility, the electric power charge can be reduced. But, if the electric power is wheeled from the transmission network 12 of the electric power utility company B to the transmission network 11 of the electric power utility company A via the interchanging transmission network 16, the electric power cannot always be freely interchanged due to obstructions such as an increase of the wheeling charge, a limitation of capacity of the interchanging transmission network 16 and the like.

In such circumstances, if the electric power generating utility Y6 supplies the electric power in an amount identical to the amount of the bought electric power supplied to the consumer Y4 to the consumer Z5 belonging to the identical transmission network 12, it is substantially equivalent to interchange of the electric power between the consumer Y4 and the electric power generating utility Y6 both of which belong to the identical utility. Moreover, since the electric power is not wheeled from the transmission network 12 to the transmission network 11 actually in this case, the increase of the wheeling charge and the limitation of the capacity of the interchanging transmission network 16 can be avoided.

In view of above, the PPS L13 issues an electric power payment bill (an electronic bill) that forces the consumer Y4 to pay the electric power in place of the electric power charge, wherein the electric power payment bill can be transferred to the PPS M14 to which the electric power generating utility Y6 belongs. Then, by forcing the electric power generating utility Y6 to fulfill the obligations of the electric power payment bill, the PPS M14 receives payment of the electric power charge from the consumer Z5 that in turn receives supply of the electric power. Through the above transaction, the PPS M14 can receive the value equivalent to the electric power payment bill bought from the PPS L13.

Though a case wherein the PPS L13 sells the electric power payment bill to the PPS M14 directly is described in the above example, the PPS L13 may alternatively sell the electric power payment bill to a broker N15. Also, by creating a market for trading electric power payment bills, liquidity of the electric power commodities can be further improved.

Further, when the electric power is traded through the electric power payment bill, the utility that is the consumer Y4 and at the same time the electric power generating utility Y6 does not need to satisfy the supply-demand simultaneity of the electric power. As a result, it is possible to buy the electric power when the electric power charge is relatively low and sell the electric power when the electric power charge is relatively high.

A processing procedure of the computer 1 in FIG. 1 to implement such trading transaction will be described with reference to FIG. 3. First, the computer 1 has outputting means for outputting to the communication network 2 a screen for electric power sellers on which electric power selling conditions are input in response to a request of the electric power generating utility X3 (S1). Thus, the screen for the electric power sellers is displayed on a terminal of the electric power seller X3. Then, when the electric power seller X3 inputs an electric power seller identification code and the electric power selling conditions on the screen, input contents are acquired by electric power sellers registering means and registered in an electric power sellers registration list (S2). Here, the electric power selling conditions may include a time period to generate the electric power, a grid (a point) for connection with the transmission line, an amount of sellable electric power, the lowest selling price, and so on. Next, the electric power selling conditions and the like registered in the electric power sellers registration list are acquired to determine areas where the registered electric power can be traded (S3). In particular, it is determined in which area and up to which amount the registered electric power can be traded based upon the capacity and current of the transmission line. Then, electric power selling information about the electric power that can be traded is published via the communication network 2 to start an auction (S4). In particular, the electric power selling conditions registered in the electric power sellers registration list are published via the communication network 2 and, on the other hand, an auction screen to which the electric power buyers can input electric power buying conditions is output to the communication network 2. Thus, the published electric power selling information and the auction screen can be displayed on the terminal of the consumer Y4, the consumer Z5 and so on. Then, consumers such as the consumer Y4 and the consumer Z5 consider the published electric power selling information and, if desired buying conditions of the consumers are satisfied, the consumers input the electric power buyer and the electric power buying conditions on the auction screen. The computer 1 acquires electric power buying information such as the electric power buyer and the electric power buying conditions and registers the electric power buying information in the electric power buyers registration list (S5).

Next, selling and buying conditions comparing means creates a comparison list including one or a plurality of the electric power buyers and the electric power buying conditions by comparing the electric power selling conditions and the electric power buying conditions and transmits the comparison list to the electric power buyers (S6). In particular, since the electric power is priced on a piecemeal basis at the auction, the computer makes a combination of the most suitable buyers and provides the combination to the electric power sellers. In response to this action, the electric power buyers select the combination that is most suitable for own electric power conditions by considering the provided comparison list, determine to buy the electric power and reply to the computer 1 via the communication network 2. The computer 1 concludes a trading contract based upon the reply from the electric power sellers and notifies the electric power buyers and the electric power sellers that are concerned of the contract (S7).

Next, according to the contract, if the electric power is to be supplied to compensate the charge to buy the electric power, the electric power payment bill (the electronic bill) is issued and stored in the computer 1 by registration (S8). Then, till the trading is completed actually, it is monitored whether a case in which the trading becomes impossible due to a cause not imputable to the parties concerned, such as trouble of a transmission network managed by a third-party electric power utility company occurs (S9). If the trading becomes impossible, all parties concerned are notified that the bill becomes invalid (S10, S12). If the case in which the trading becomes impossible does not occur, the electric power systems are monitored continuously to make sure that the trading is executed actually (S11). Especially, in order to monitor the transmission networks and check the amount of the electric power that is sold and bought, it is necessary to monitor the electric power systems in the entire country or in plural regional blocks for which the electric power payment bill can be issued all the time continuously. Though the transmission networks in the territory of electric power utility companies are well maintained, transmission capacity is restricted severely in interchanging transmission lines among power companies, therefore the trading of the electric power among the power companies must be monitored. In order to perform such monitoring, predictions and condition monitoring by the computer are indispensable.

As describe above, the present invention can improve liquidity of electric power as a commodity and substantially alleviate simultaneity of electric power supply. Further, according to the present invention, it is possible to implement wheeling of the electric power among different regional blocks without restriction of the amount of interchangeable electric power, power supply frequency and the like.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. An electric power trading market system comprising a computer that is managed by an electric power trading market administrator and connected to a communication network, said computer comprising:
outputting means for outputting to said communication network a screen for electric power sellers on which the electric power sellers and electric power selling conditions are input;
electric power sellers registering means for registering said electric power sellers and said electric power selling conditions that are input on said screen for the electric power sellers;
auctioning means for publishing said electric power selling conditions registered in said electric power sellers registering means via said communication network to put up to auction for electric power buyers;
electric power buyers registering means for registering said electric power buyers and electric power buying conditions that are input in response to said auction;
selling and buying conditions comparing means for creating a comparison list including one or a plurality of said electric power buyers and the electric power buying conditions by comparing said electric power selling conditions and said electric power buying conditions and for transmitting the comparison list to said electric power sellers; and
contracting means for concluding a trading contract based upon a reply to said comparison list from said electric power sellers and for transmitting the trading contract to said electric power sellers and said electric power buyers that are concerned via said communication network.

2. An electric power trading market system according to claim 1, wherein said computer further comprises electronic bill issuing means for issuing an electronic bill that describes electric power payment obligations according to which the electric power buyers in said trading contract must supply electric power corresponding to the amount of the bought electric power at an arbitrary time period in place of payment of an electric power charge when said trading contract is concluded.

3. An electric power trading market system according to claim 2, wherein said electric power trading market administrator can transfer the electronic bill issued by said electronic bill issuing means to another party and the party to which the electronic bill is transferred has a right to be supplied the amount of the electric power specified in the electronic bill at an arbitrary time period in an arbitrary region subject to management by said electric power trading market administrator.

4. An electric power trading market system according to claim 3, wherein said area that is subject to the management by said electric power trading market administrator includes a plurality of regional blocks that are managed by a plurality of electric power utility companies.

5. An electric power trading market system according to claim 1, wherein said computer further comprises monitoring means for managing execution of said trading contract concluded by said contracting means, said monitoring means monitoring the electric power selling conditions and the electric power buying conditions according to said trading contract via communicating means such as said communication network.

6. An electric power trading market system according to claim 5, wherein said monitoring means notifies said electric power sellers and said electric power buyers that said issued electronic bill becomes invalid if said monitoring means determines that it is difficult to execute said trading contract concluded by said contracting means.

7. An electric power trading market system according to claim 1, wherein said electric power trading market administrator is a power producer and supplier or a third-party organization.

8. An electric power trading market system according to claim 1, wherein said electric power sellers includes at least one of electric power generating utilities and the power producer and suppliers while the electric power buyers includes at least one of consumers and the power producer and suppliers.

9. An electric power trading method for trading electric power using a computer connected to a communication network, comprising the steps of:
outputting from the computer that manages an electric power trading market to said communication network a screen for electric power sellers on which the electric power sellers and electric power selling conditions are input;
registering said electric power sellers and said electric power selling conditions that are input on said screen for the electric power sellers by electric power sellers registering means;
publishing said electric power selling conditions registered in said electric power sellers registering means via said communication network and outputting an auctioning screen to which electric power buyers can input electric power buying conditions;
registering by electric power buyers registering means the electric power buyers who input the electric power buying conditions to said auctioning screen and the electric power buying conditions that are input by said electric power buyers;
creating a comparison list including one or a plurality of said electric power buyers and the electric power buying conditions by comparing said electric power selling conditions and said electric power buying conditions and outputting the comparison list for said electric power sellers to said communication network;
concluding a trading contract based upon a reply to said comparison list from said electric power sellers; and
outputting contract information of the electric power trade to said electric power sellers and said electric power buyers that are concerned.

10. An electric power trading method for trading electric power using a computer connected to a communication network, comprising the steps of:
outputting from the computer that manages an electric power trading market to said communication network a screen for electric power sellers on which the electric power sellers and electric power selling conditions are input;
registering said electric power sellers and said electric power selling conditions that are input on said screen for the electric power sellers by electric power sellers registering means;
publishing said electric power selling conditions registered in said electric power sellers registering means via said communication network and outputting an auctioning screen to which electric power buyers can input electric power buying conditions;
registering in electric power buyers registering means the electric power buyers who input the electric power buying conditions to said auctioning screen and the electric power buying conditions that are input by said electric power buyers;
creating a comparison list including one or a plurality of said electric power buyers and the electric power buying conditions by comparing said electric power selling conditions and said electric power buying conditions and outputting the comparison list for said electric power sellers to said communication network; and
concluding in said computer a trading contract based upon a reply to said comparison list from said electric power sellers and issuing to the electric power buyers in said trading contract an electronic bill that describes electric power payment obligations according to which said electric power buyers must supply electric power corresponding to the amount of the bought electric power at an arbitrary time period in place of payment of an electric power charge.
